(19) United States
(12) Patent Application Publication
(10) Pub. No.: US 2025/0383905 A1
(43) Pub. Date: Dec. 18, 2025

(54) MAINTAINING A VIRTUAL MACHINE'S NETWORK CONFIGURATION THROUGH A MIGRATION PROCESS

(71) Applicant: RED HAT, INC., Raleigh, NC (US)

(72) Inventors: Arik Hadas, Herzliya (IL); Tomas Golembiovsky, Staric (CZ)

(21) Appl. No.: 18/744,867

(22) Filed: Jun. 17, 2024

(51) Int. Cl. G06F 9/455; G06F 9/445

(52) U.S. Cl. CPC G06F 9/45558; G06F 9/44505; G06F 2009/4557; G06F 2009/45595

(57) ABSTRACT

In one example, a system can receive a user selection of a virtual machine (VM) to migrate from a source computing environment to a target computing environment. Based on receiving the selection, and prior to performing the migration process, the system can determine network configuration data associated with the VM. The system can then initiate the migration process to migrate the VM from the source computing environment to the target computing environment. The migration process may involve replacing a first network card driver used by the VM at the source computing environment with a second network card driver used by the VM in the target computing environment. Replacing the first network card driver with the second network card driver may erase the network configuration data from the VM. The system can then configure the VM in the target computing environment based on the network configuration data it previously acquired.

### TECHNICAL FIELD

The present disclosure relates generally to software migration between computing environments. More specifically, but not by way of limitation, this disclosure relates to maintaining a virtual machine's network configuration through a migration process between computing environments.

### BACKGROUND

Virtual machines are one popular mechanism for deploying isolated computing environments on a computer system. A virtual machine is an emulation (virtualization) of an actual physical computer system. Virtual machines include virtualized hardware and guest software. The virtualized hardware can emulate corresponding physical components that exist in a physical computer system. Examples of the virtualized hardware can include virtual central processing units (vCPUs), virtual random access memory (vRAM), virtual network interfaces, and virtual storage. The guest software can be any software programs that execute on top of the virtual machine. Examples of the guest software can include a guest operating system, a guest supervisory program, and one or more guest applications. Virtual machines are generally deployed as guests on a host operating system using virtualization software, such as a hypervisor. Guest software of the virtual machine is generally given limited access to the physical resources of the underlying host computing device.

It may be desirable to migrate a virtual machine from a source computing environment to a target computing environment. The target computing environment generally has different characteristics (e.g., a different operating system or node topology) than the source computing environment, and the purpose of the migration is to take advantage of those different characteristics. For example, a system administrator may migrate a virtual machine from an on-premises server to a cloud computing environment to take advantage of the improvements to scaling, reliability, and affordability provided by cloud computing architectures. As another example, a system administrator may migrate a virtual machine from a computing cluster running an older version of Red Hat Enterprise Linux (RHEL) to another computing cluster running a newer version of RHEL, which may provide improved stability or enhanced features relative to the older version.

### BRIEF DESCRIPTION OF THE DRAWINGS

FIG. 1 shows a block diagram of an example of a system for maintaining a virtual machine's network configuration through a migration process between computing environments according to some aspects of the present disclosure.

FIG. 2 shows a block diagram of an example of a system that includes a migration engine for determining the network configuration of a virtual machine in a source computing environment, according to some aspects of the present disclosure.

FIG. 3 shows an example of a report that includes network configuration data according to some aspects of the present disclosure.

FIG. 4 shows a flowchart of an example of a process for migrating and configuring one or more virtual machines according to some aspects of the present disclosure.

FIG. 5 shows a flowchart of an example of a process for configuring a virtual machine at a target computing environment based on network configuration data collected from a source computing environment, according to some aspects of the present disclosure.

FIG. 6 shows a block diagram of an example of a system for maintaining a virtual machine's network configuration through a migration process between computing environments according to some aspects of the present disclosure.

FIG. 7 shows a flowchart of an example of a process for maintaining a virtual machine's network configuration through a migration process between computing environments according to some aspects of the present disclosure.

### DETAILED DESCRIPTION

A virtual machine running in a source computing environment may have a network card driver for use with a network card of the virtual machine. The network card driver is virtualized driver software for use with the network card, where the network card is virtualized network card hardware. As the network card is used to perform network functions by the virtual machine, the network card driver may store network configuration data related to those network functions. For example, the network card driver may store network configuration data such as static Internet Protocol (IP) addresses assigned to the virtual machine, open ports on the virtual machine, client connections with the virtual machine, etc.

For various reasons, it may be desirable to migrate the virtual machine from the source computing environment to a target computing environment. In many scenarios, the network card driver of the virtual machine may be replaced with another network card driver during the migration process. For example, if the hypervisor in the target computing environment is of a different type than the hypervisor in the source computing environment, then the network card driver may need to be replaced during the migration process for compatibility reasons—e.g., for compatibility with the hypervisor of the target computing environment. As another example, if the virtual machine is running on OpenShift® by Red Hat® in the source computing environment and will run on OpenStack by Red Hat® in the target computing environment, differences between these two frameworks may require the network card driver of the virtual machine to be replaced with another network card driver during the migration process.

When the network card driver of the virtual machine is replaced with a different network card driver at the target computing environment, the network configuration data associated with the original network card driver may be erased. This loss of network configuration data can result in problems with the networking operations of the virtual machine at the target computing environment. For example, data may not be properly directed to the virtual machine or its applications in the target computing environment. A system administrator may need to intervene to manually fix such problems, for example by manually setting up the new network card driver of the virtual machine in the target computing environment with the appropriate settings. Since those settings may no longer be available at the source computing environment, this may take considerable trial and error, which can lead to system downtime until the problems are fixed.

Some examples of the present disclosure can overcome one or more of the abovementioned problems by automatically maintaining a virtual machine's network configuration through a migration process, which may involve replacing the network card driver of the virtual machine. More specifically, a migration engine that is supervising the migration process can inspect the virtual machine at the source computing environment, prior to initiating the migration process. The migration engine can inspect the virtual machine to obtain data about its network configuration. This network configuration data may indicate a set of applications executing on the virtual machine, a set of ports used by the set of applications in the virtual machine, a set of clients that accessed the set of applications via the set of ports, and/or a static IP address associated with the virtual machine, among other networking information. After obtaining the network configuration data, the migration engine can execute the migration process to migrate the virtual machine to the target computing environment. This migration process may involve replacing a first network card driver, of the virtual machine at the source computing environment, with a second network card driver at the target computing environment. Due to the first network card driver being replaced with the second network card driver, the network configuration data stored in the first network card driver may be erased (and thus may be erased from the virtual machine), as discussed above. To avoid the problems that may otherwise arise due to the network configuration data being erased, the migration engine can automatically configure the second network card driver based on the network configuration data that it acquired earlier. For example, the migration engine can assign the static IP address, identified in the network configuration data, to the virtual machine in the target computing environment. As another example, the migration engine can open the set of ports, identified in the network configuration data, on the virtual machine in the target computing environment. This may help ensure that network connectivity is properly established, and data is properly routed to and from the virtual machine.

In some examples, prior to the second network card driver being configured based on the network configuration data, a user that is overseeing the migration process may be presented with at least some of the network configuration data. For instance, the migration engine can provide a report that includes the network configuration data to the user. The migration engine can provide the report in an interactive graphical user interface (GUI) through which the user may selectively modify at least some of the network configuration data, for example to resolve a compatibility issue that may arise as a result of the migration. The migration engine can then configure the second network card driver of the virtual machine in the target computing environment based on the modified network configuration data.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

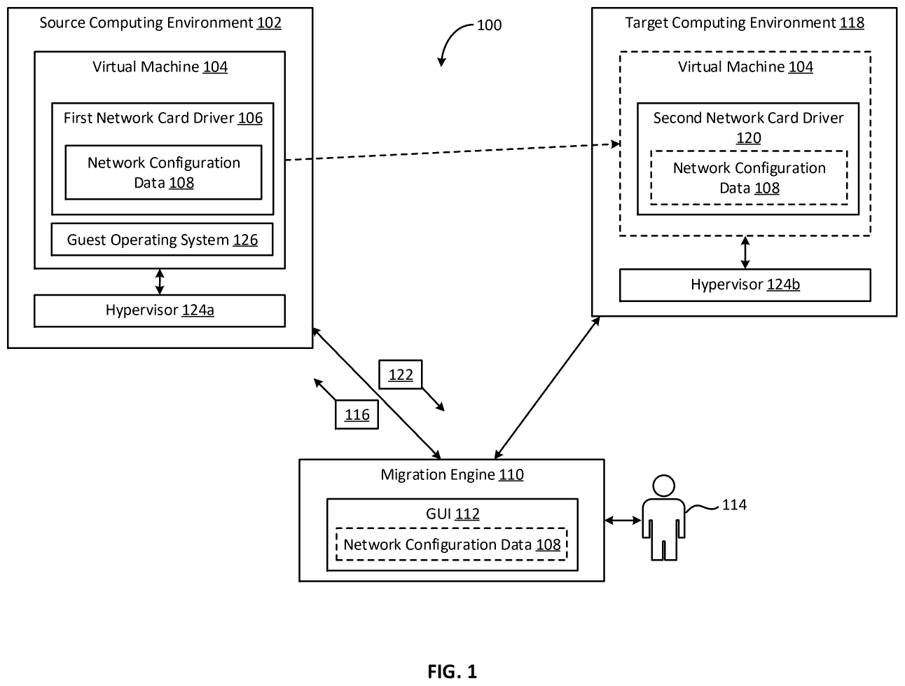

FIG. 1 shows a block diagram of an example of a system 100 for maintaining a virtual machine's 104 network configuration through a migration process between computing environments 102, 118 according to some aspects of the present disclosure. The system 100 includes a source computing environment 102 that is executing the virtual machine 104 prior to the migration process. The system 100 also includes a target computing environment 118 that will be running the virtual machine 104 after the migration process. The target computing environment 118 is different from the source computing environment 102 and has one or more characteristics that differ from the source computing environment 102. For instance, the target computing environment 118 may include an operating system, a virtual machine orchestration platform, a hypervisor, or a framework that differs from the source computing environment 102. These different characteristics may be the reason for the migration—e.g., to take advantage of these characteristics that are absent from the source computing environment 102.

The system 100 can also include a migration engine 110 that can facilitate the migration process. The migration engine 110 can be located in the source computing environment 102, the target computing environment 118, or elsewhere. The migration engine 110 can be operated by a user 114, such as a system administrator, to facilitate the migration process. For example, the user 114 can interact with a graphical user interface (GUI) 112 of the migration engine 110 to start, stop, or modify aspects of the migration process.

In some examples, the migration engine 110 can communicate with the source computing environment 102 to determine which, if any, virtual machines are running in the source computing environment 102. For example, the migration engine 110 can transmit a request 116 for virtual machine details to the source computing environment 102. The request 116 may be transmitted to an application programming interface (API) of the source computing environment 102. In response to the request 116, the source computing environment 102 can inspect itself to determine which virtual machines are running. The source computing environment 102 can then provide details about the running virtual machines to the migration engine 110 in a response 122 to the request 116. In the example shown in FIG. 1, the source computing environment 102 can inspect itself to determine that the virtual machine 104 is running. The source computing environment 102 can then provide a unique identifier of the virtual machine 104 to the migration engine 110. In other examples, there may be additional virtual machines running in the source computing environment 102 for which corresponding details can be transmitted to the migration engine 110.

The migration engine 110 can output a list of the one or more virtual machines running in the source computing environment 102 to the user 114. For example, the migration engine 110 can output the list to the user 114 via the GUI 112. The user 114 can then select at least a subset of the virtual machines on the list for migration to the target computing environment 118. In the example shown in FIG. 1, the user 114 has selected the virtual machine 104 for migration to the target computing environment 118, but in other examples the user 114 may select additional virtual machines for migration to the target computing environment 118.

Prior to migrating each of the selected virtual machines from the source computing environment 102 to the target computing environment 118, the migration engine 110 can obtain network configuration data associated with each of the selected virtual machines. For example, the migration engine 110 can communicate (e.g., directly) with the virtual machine 104 or its hypervisor 124a to determine the network configuration data 108. In other examples, the migration engine 110 can transmit a request for the network configuration data 108 associated with the virtual machine 104 to the source computing environment 102. The request may be transmitted to an API of the source computing environment 102. In response to the request, the source computing environment 102 can inspect the virtual machine 104 to determine its network configuration data 108. For example, the source computing environment 102 can obtain at least some of the network configuration data 108 from the first network card driver 106, which may store the network configuration data 108. Additionally or alternatively, the source computing environment 102 can obtain at least some of the network configuration data 108 from a guest operating system 126 of the virtual machine 104, for example by transmitting commands to the guest operating system for a list of running applications, a list of open ports, and/or a list of client connections. Additionally or alternatively, the source computing environment 102 can obtain at least some of the network configuration data 108 from a hypervisor 124a managing the virtual machine 104, for example by transmitting commands to the hypervisor 124a for a list of running applications, a list of open ports, and/or a list of client connections. The source computing environment 102 can then provide the network configuration data 108 to the migration engine 110 in a response to the request.

After receiving the network configuration data for a given virtual machine that is to be migrated, the migration engine 110 can output at least some of the network configuration data in the GUI 112. For example, after receiving the network configuration data 108 for the virtual machine 104, the migration engine 110 can output at least some of the network configuration data 108 in the GUI 112. The network configuration data for a given virtual machine may be output as a report or in another format. The user 114 can then review and approve the network configuration data—e.g., if it is suitable for the target computing environment 118. If the user 114 wishes to make a change to the network configuration data, the user 114 can input at least one modification to the network configuration data via the GUI 112. For instance, the user 114 can modify a static IP address listed in the network configuration data 108 of the virtual machine 104 using the GUI 112.

The migration process for each of the selected virtual machines can be initiated after its network configuration data has been reviewed and approved by the user 114. Alternatively, this approval stage may be skipped for one or more of the virtual machines and the migration process may be automatically initiated for those virtual machines. Either way, the migration engine 110 can facilitate the migration process for a given virtual machine by interacting with the source computing environment 102, the target computing environment 118, or both. For example, the migration engine 110 can facilitate the migration process for the virtual machine 104 by interacting with the source computing environment 102 and the target computing environment 118. These interactions may take place via APIs of the source computing environment 102 and the target computing environment 118. Migrating the virtual machine 104 may involve transferring some or all of the state data (e.g., application data and runtime state data) of the virtual machine 104 from the source computing environment 102 to the target computing environment 118, for example so that the virtual machine 104 can pick up in the target computing environment 118 where it left off in the source computing environment 102. At the conclusion of the migration process, the virtual machine 104 may be deployed in the target computing environment 118 (e.g., using the hypervisor 124b) and may be shut down in the source computing environment 102.

As part of the migration process, a first network card driver of a given virtual machine may be deleted or replaced. For instance, the first network card driver 106 of the virtual machine 104 in the source computing environment 102 may be deleted or replaced by a second network card driver 120, which is different from (e.g., a different version or type from) the first network card driver 106. Deleting or replacing the first network card driver 106 may erase at least some of the network configuration data 108, which was previously stored in the first network card driver 106, from the virtual machine 104. As a result, when the virtual machine 104 is initially deployed in the target computing environment 118, it may be missing this network configuration data 108. Without the network configuration data 108, the virtual machine 104 may fail to operate properly in the target computing environment 118.

To help overcome the abovementioned problems, the migration engine 110 can configure a given virtual machine, after it has been deployed in the target computing environment 118, based on the corresponding network configuration data that was previously acquired. For instance, the migration engine 110 can configure the virtual machine 104, after it is initially deployed in the target computing environment 118, based on the network configuration data 108 (e.g., the original network configuration data 108, or the modified version of the network configuration data 108 as adjusted by the user 114) that it previously obtained. Configuring the virtual machine 104 may involve adjusting one or more settings of the second network card driver 120. For instance, a setting value for the second network card driver 120 may be adjusted to match a corresponding setting value in the network configuration data 108. The migration engine 110 can configure the virtual machine 104 in this way by transmitting one or more commands to the target computing environment 118 (e.g., to an API of the target computing environment 118, to the virtual machine 104 therein, to the hypervisor 124b, or to any combination of these). Once the virtual machine 104 has been configured based on the network configuration data 108, the virtual machine 104 may function better within the target computing environment 118 than before the configuration.

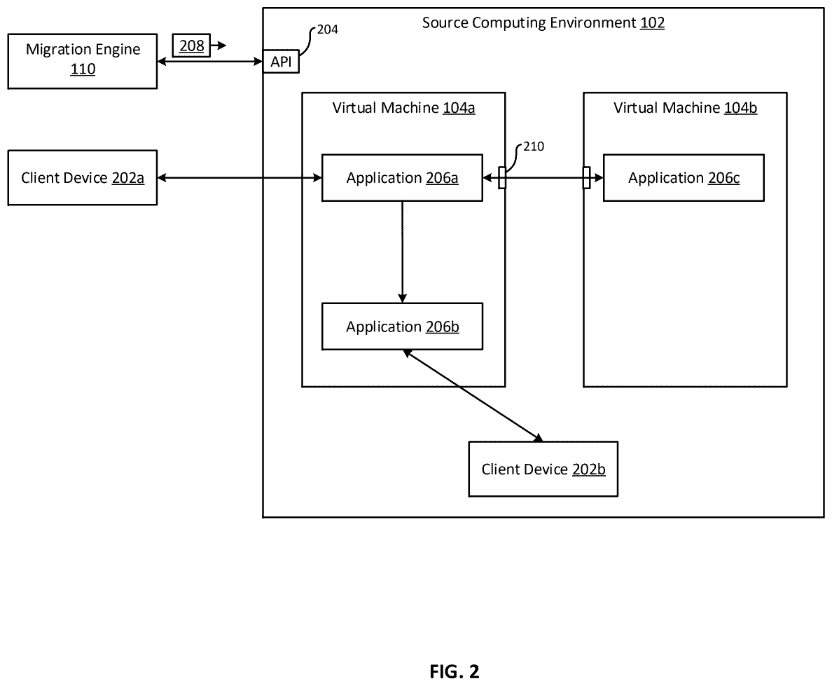

Turning now to FIG. 2, as discussed above, the migration engine 110 may perform an inspection process to determine network configuration data associated with a virtual machine 104a. For example, if the migration engine 110 is external to the source computing environment 102, the migration engine 110 may determine the network configuration data by transmitting commands 208 to an API 204 of the source computing environment 102. As another example, if the migration engine 110 is internal to the source computing environment 102, the migration engine 110 may determine the network configuration data by transmitting commands 208 to the API 204, the virtual machine 104a, and/or its hypervisor.

In the example of FIG. 2, the migration engine 110 may perform the inspection process to determine that the virtual machine 104a includes two applications 206a-b, though other examples may involve more or fewer applications. The migration engine 110 may also determine whether and how the applications 206a-b interact with one another in the virtual machine 104a. For instance, the migration engine 110 may determine that application 206a transmits data to application 206b. Additionally, the migration engine 110 may determine whether and how the applications 206a-b in the virtual machine 104a interact with other applications outside the virtual machine 104a, such as applications in other virtual machines. For instance, the migration engine 110 may determine that the application 102a interacts with another application 106c in another virtual machine 104b over a network via a particular port 210. The migration engine 110 may further determine whether and how client devices (e.g., laptop computers, desktop computers, servers, mobile phones, etc.) interact with the applications 206a-b in the virtual machine 104a. For example, the migration engine 110 may determine that at least one client device 202a that is external to the source computing environment 102 interacts with application 206a. Similarly, the migration engine 110 may determine that at least one client device 202b internal to the source computing environment 102 interacts with application 206b.

Some or all of the above information may constitute the network configuration data associated with the virtual machine 104a. For example, the network configuration data associated with the virtual machine 104a can specify the set of applications 104a-b, the port 210, the set of clients 202a-b, and other information such as one or more static IP addresses assigned to the virtual machine 104a. The network configuration data may further specify whether each of the clients 202a-b is internal or external to the source computing environment 102. By performing the inspection process, the migration engine 110 can obtain the relevant network configuration data for use in the migration process.

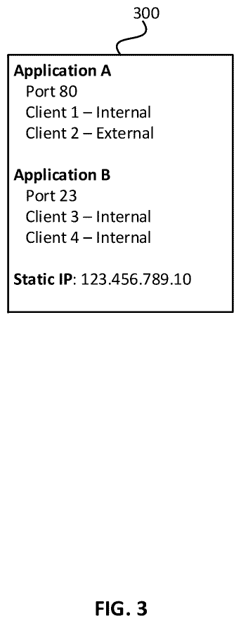

Turning now to FIG. 3, shown is an example of a report 300 that includes network configuration data associated with a virtual machine according to some aspects of the present disclosure. In this example, the network configuration data indicates that there are two applications (A and B) running in the virtual machine. Application A uses port 80 to communicate with two client devices, one of which is internal to the source computing environment and one of which is external to the source computing environment. Application B uses port 23 to communicate with two client devices, both of which are internal to the source computing environment. The network configuration data also indicates that there is a static IP address of 123.456.789.10 assigned to the virtual machine. Some or all of this information may be presented to the user in a GUI (e.g., GUI 112) prior to performing the migration process associated with the virtual machine. This may allow the user to approve, reject, or modify the network configuration data.

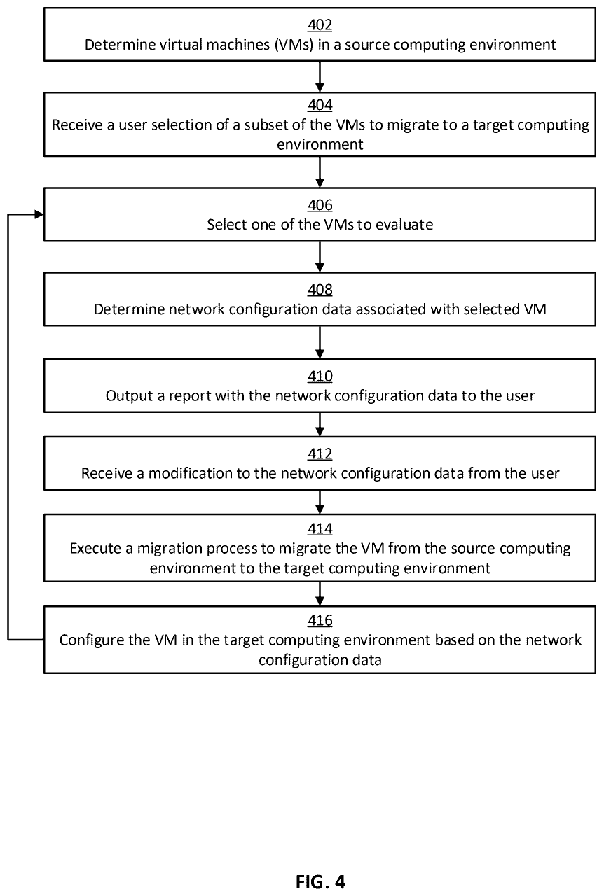

Turning now to FIG. 4, shown is a flowchart of an example of a process for migrating and configuring one or more virtual machines according to some aspects of the present disclosure. Other examples may involve more operations, fewer operations, different operations, or a different sequence of operations than is shown in FIG. 4. The operations of FIG. 4 are described below with reference to the components of FIG. 1.

In block 402, the migration engine 110 determines virtual machines in a source computing environment 102. If the migration engine 110 is external to the source computing environment 102, this may involve the migration engine 110 transmitting one or more commands (e.g., via one or more networks) to an API of the source computing environment 102. The source computing environment 102 can respond to the commands by performing an inspection process to determine which virtual machines are currently running and transmitting that information to the migration engine 110. If the migration engine 110 is internal to the source computing environment 102, the migration engine 110 may transmit said commands to the API or, alternatively, may be able to perform the inspection process itself to determine which virtual machines are currently running.

In block 404, the migration engine 110 receives a user selection of at least a subset of the virtual machines for migration to a target computing environment 118. For example, if the source computing environment 102 is running 115 virtual machines, the user 114 may select 11 of the virtual machines for migration. The user 114 can select the subset of virtual machines via a GUI 112 of the migration engine 110.

In block 406, the migration engine 110 selects a virtual machine 104 from the subset to evaluate. The migration engine 110 can randomly select the virtual machine 104 or may use another scheme to select the virtual machine 104.

In block 408, the migration engine 110 determines network configuration data 108 associated with the virtual machine 104. For example, the migration engine 110 can first determine whether the selected virtual machine 104 is accessible. If so, the migration engine 110 may interact (e.g., directly) with the virtual machine 104 to inspect the virtual machine 104 and thereby determine the network configuration data 108. But in some situations, the migration engine 110 may not be able to access the virtual machine 104 for any number of reasons, such as a poor network connection, incorrect authentication credentials (e.g., username/password), a failed endpoint, etc. If the migration engine 110 cannot access the virtual machine 104, then the migration engine 110 may try other methods to obtain the network configuration data 108, such as interacting with the source computing environment 102 via an API. If none of those other methods work, the migration engine 110 may perform the migration process without first acquiring the network configuration data 108. For instance, the migration engine 110 may forego performing the inspection process to acquire the network configuration data 108 prior to executing the migration. A system administrator may then manually configure the migrated virtual machine 104 in the target computing environment 118 using conventional techniques. On the other hand, if at least one of the other methods works, then the migration engine 110 may obtain the network configuration data 108 for use in the migration.

In block 410, the migration engine 110 outputs a report with the network configuration data 108 to the user 114. For example, the migration engine 110 can output the report in the graphical user interface 112.

In block 412, the migration engine 110 receives a modification to the network configuration data 108 from the user 114. For example, the user 114 may input the modification via the graphical user interface 112. The modification can include at least one change to at least one setting value in the network configuration data 108.

In block 414, the migration engine 110 executes the migration process to migrate the virtual machine 104 from the source computing environment 102 to the target computing environment 118. In particular, the migration engine 110 may serve as a centralized coordinator of the migration process by issuing commands to the computing environments 102,118. For instance, the migration engine 110 can transmit commands to the computing environments 102,118 for causing state data associated with the virtual machine 104 to be transferred from the source computing environment 102 to the target computing environment 118, the virtual machine 104 to be shut down in the source computing environment 102, and the virtual machine 104 to be deployed using the state data in the target computing environment 118.

In block 416, the migration engine 110 configures the virtual machine 104 in the target computing environment 118 based on the network configuration data 108. For example, the migration engine 110 can issue commands to the target computing environment 118 (e.g., the virtual machine 104, its hypervisor 124b, or an API of the target computing environment 118) to configure the virtual machine 104 based on the network configuration data 108. This “network configuration data” may be the original network configuration data as acquired from the source computing environment 102, or it may be the modified network configuration data as adjusted by the user 114.

The process can then return to block 406, where another virtual machine can be selected from the subset for evaluation and blocks 408-416 can repeat. This process can iterate until a stopping condition is satisfied, which may be for example that all virtual machines in the subset have been evaluated.

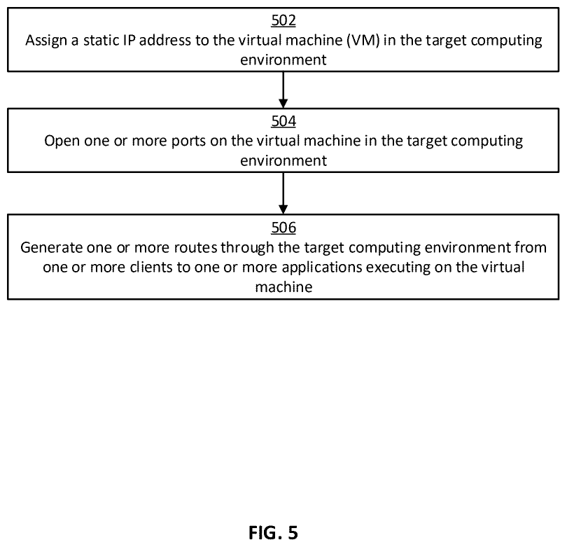

As noted above, the migration engine 110 configures the virtual machine 104 in the target computing environment 118 based on the network configuration data 108. One example of a process for performing such configuring is shown in FIG. 5, which will now be described with respect to the components of FIG. 1. Of course, other examples may involve more operations, fewer operations, different operations, or a different sequence of operations than is shown in FIG. 5.

In block 502, the migration engine 110 assigns a static IP address to the virtual machine 104 in the target computing environment 118. In some examples, this may involve the migration engine 110 transmitting one or more commands to the target computing environment 118 (e.g., its API or the virtual machine 104 therein) for causing the static IP address to be assigned to the virtual machine 104. In other words, the migration engine 110 may not itself do the assigning, but rather may interact with other components to facilitate the assignment. The migration engine 110 can determine the static IP address from the network configuration data 108 associated with the virtual machine 104.

In block 504, the migration engine 110 opens one or more ports on the virtual machine 104 in the target computing environment 118. In some examples, this may involve the migration engine 110 transmitting one or more commands to the target computing environment 118 (e.g., its API or the virtual machine 104 therein) for causing the one or more ports to be opened on the virtual machine 104. In other words, the migration engine 110 may not itself open the ports, but rather may interact with other components to facilitate the opening of the ports. The migration engine 110 can determine the one or more ports to open from the network configuration data 108 associated with the virtual machine 104.

In block 506, the migration engine 110 generates one or more routes, through the target computing environment 118, from one or more clients to one or more applications executing on the virtual machine 104. A route can be a data pathway through a computing environment from a source to a destination.

In some examples, to generate a route from an external client device to an application of the virtual machine 104, the migration engine 110 can transmit one or more commands to the target computing environment 118 (e.g., its API) for causing an endpoint to be established. The endpoint can be used for transferring data from the external client device to the application and vice versa. For instance, the migration engine 110 can interact with the target computing environment 118 to establish an endpoint that exposes an application of the virtual machine 104 to a client device that is external to the target computing environment 118.

In some examples, to generate a route from an internal client device to an application, the migration engine 110 can transmit one or more commands to the target computing environment 118 (e.g., its API) for causing a pointer to be established that refers to the application. The pointer can be a name or other unique identifier for the application. The pointer can be used by a client device that is internal to the target computing environment 118 for interacting with (e.g., accessing) the application.

By implementing one or more of these steps, the migration engine 110 can help ensure that the virtual machine 104 is configured with the correct static IP addresses, ports, endpoints, and/or pointers for proper operation in the target computing environment 118.

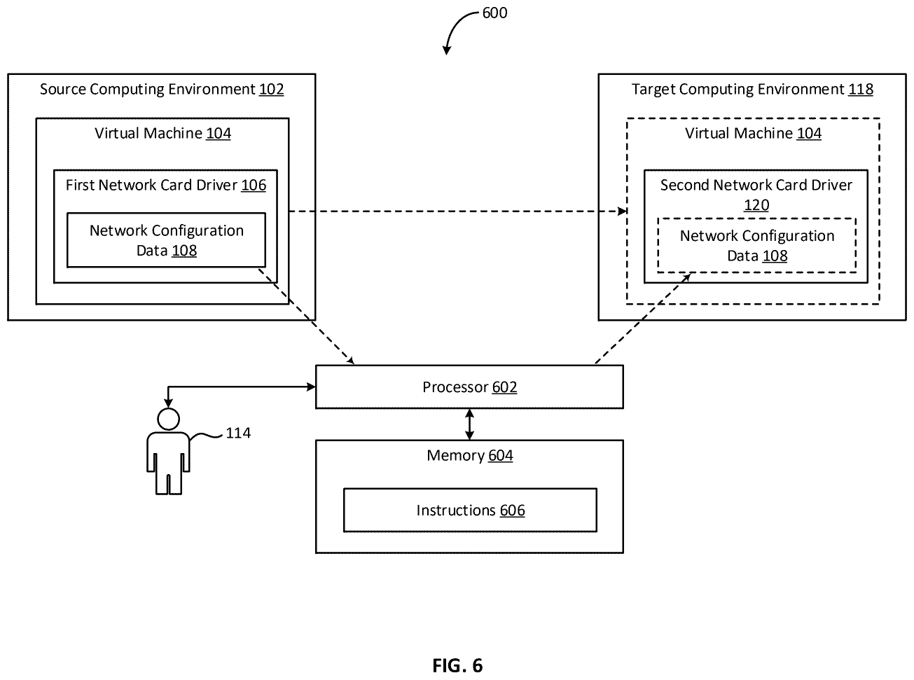

Turning now to FIG. 6, shown is a block diagram of an example of a system 600 for maintaining a virtual machine's network configuration through a migration process between computing environments according to some aspects of the present disclosure. The system 600 includes a processor 602 communicatively coupled to a memory 604. The processor 602 is hardware that can include one processing device or multiple processing devices. The processor 602 can execute instructions 606 stored in the memory 604 to perform one or more operations. In some examples, the instructions 606 can include processor-specific instructions generated by a compiler or an interpreter from code written in any suitable computer-programming language, such as C, C++, C #, or Java.

The memory 604 is hardware that can include one memory device or multiple memory devices. The memory 604 can be volatile or non-volatile (it can retain stored information when powered off). Examples of the memory 604 include electrically erasable and programmable read-only memory (EEPROM) or flash memory. At least a portion of the memory device includes a non-transitory computer-readable medium. A computer-readable medium can include electronic, optical, magnetic, or other storage devices capable of providing the processor 602 with the instructions 606 or other program code. Examples of a computer-readable medium include magnetic disks, memory chips, ROM, RAM, an ASIC, a configured processor, optical storage, or any other medium from which a computer processor can read the instructions 606.

The processor 602 can execute the instructions 606 to perform operations. For example, the processor 602 can receive a selection by a user 114 of a virtual machine 104 to migrate from a source computing environment 102 to a target computing environment 118 during a migration process. Based on receiving the selection, and prior to performing the migration process, the processor 602 can determine network configuration data 108 associated with the virtual machine 104. The network configuration data 108 may be stored in a first network card driver 106. After determining the network configuration data 108, the processor 602 can initiate the migration process to migrate the virtual machine 104 from the source computing environment 102 to the target computing environment 118. The migration process can involve replacing the first network card driver 106 used by the virtual machine 104 at the source computing environment 102 with a second network card driver 120 used by the virtual machine 104 in the target computing environment 118. Replacing the first network card driver 106 with the second network card driver 120 during the migration process may erase the network configuration data 108 from the virtual machine 104. After deploying the virtual machine 104 to the target computing environment 118, the processor 602 can configure the virtual machine 104 based on the network configuration data 108.

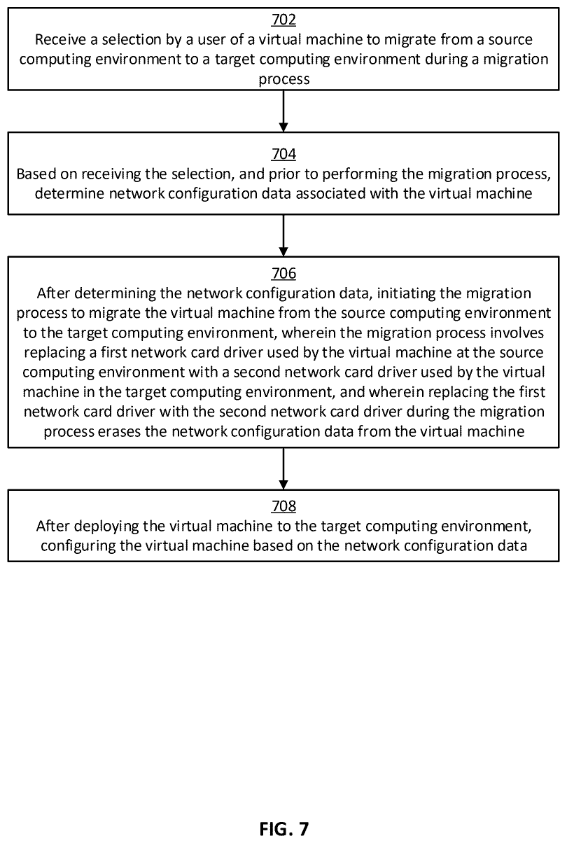

Turning now to FIG. 7, shown is a flowchart of an example of a process for maintaining a virtual machine's network configuration through a migration process between computing environments according to some aspects of the present disclosure. Other examples may involve more operations, fewer operations, different operations, or a different sequence of operations than is shown in FIG. 7. The operations of FIG. 7 are described below with reference to the components of FIG. 6.

In block 702, the processor 602 receives a selection by a user 114 of a virtual machine 104 to migrate from a source computing environment 102 to a target computing environment 118 during a migration process.

In block 704, based on receiving the selection, and prior to performing the migration process, the processor 602 determines network configuration data 108 associated with the virtual machine 104. The network configuration data 108 may be retrieved from a first network card driver 106 of the virtual machine 104, a guest operating system of the virtual machine 104, a hypervisor associated with the virtual machine 104, or any combination of these.

In block 706, after determining the network configuration data 108, the processor 602 initiates the migration process to migrate the virtual machine 104 from the source computing environment 102 to the target computing environment 118. The migration process can involve replacing the first network card driver 106 used by the virtual machine 104 at the source computing environment 102 with a second network card driver 120 used by the virtual machine 104 in the target computing environment 118. Replacing the first network card driver 106 with the second network card driver 120 during the migration process may erase the network configuration data 108 from the virtual machine 104.

In block 708, after deploying the virtual machine 104 to the target computing environment 118, the processor 602 configures the virtual machine 104 based on the network configuration data 108. This may involve establishing endpoints and/or pointers, based on the network configuration data 108, to direct traffic to and from the virtual machine 104. Additionally or alternatively, this may involve opening ports (e.g., network connection ports) on the virtual machine 104 based on the network configuration data 108. Additionally or alternatively, this may involve assigning IP addresses (e.g., static IP addresses) to the virtual machine 104 based on the network configuration data 108.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A non-transitory computer-readable medium comprising program code that is executable by one or more processors for causing the one or more processors to perform operations including:
receiving a selection by a user of a virtual machine to migrate from a source computing environment to a target computing environment during a migration process;
based on receiving the selection, and prior to performing the migration process, determining network configuration data associated with the virtual machine;
after determining the network configuration data, initiating the migration process to migrate the virtual machine from the source computing environment to the target computing environment, wherein the migration process involves replacing a first network card driver used by the virtual machine at the source computing environment with a second network card driver used by the virtual machine in the target computing environment, and wherein replacing the first network card driver with the second network card driver during the migration process erases the network configuration data from the virtual machine; and
after deploying the virtual machine to the target computing environment, configuring the virtual machine based on the network configuration data.

2. The non-transitory computer-readable medium of claim 1, wherein the network configuration data specifies (i) a set of applications executing on the virtual machine, (ii) a set of ports used by the set of applications in the virtual machine, (iii) a set of clients that accessed the set of applications via the set of ports, and (iv) one or more static Internet Protocol (IP) addresses associated with the virtual machine.

3. The non-transitory computer-readable medium of claim 2, wherein configuring the virtual machine involves:
assigning the static IP address to the virtual machine in the target computing environment;
opening the set of ports on the virtual machine in the target computing environment; and
generating a set of routes through the target computing environment from the set of clients to the set of applications.

4. The non-transitory computer-readable medium of claim 3, wherein a client among the set of clients is external to the target computing environment, and wherein generating the set of routes involves establishing an endpoint that exposes at least one application of the set of applications externally to the client.

5. The non-transitory computer-readable medium of claim 3, wherein a client among the set of clients is internal to the target computing environment, and wherein generating the set of routes involves establishing a pointer to at least one application of the set of applications, the client being configured to interact with the at least one application using the pointer.

6. The non-transitory computer-readable medium of claim 1, wherein the operations further comprise:
determining whether the virtual machine is accessible to the one or more processors; and
based on determining that the virtual machine is accessible, inspecting the virtual machine to determine the network configuration data.

7. The non-transitory computer-readable medium of claim 1, wherein the virtual machine is a first virtual machine and the network configuration data is first network configuration data, and wherein the operations further comprise:
determining that a second virtual machine is inaccessible to the one or more processors;
based on determining that the second virtual machine is inaccessible, foregoing inspecting the second virtual machine at the source computing environment; and
initiating the migration process to migrate the second virtual machine from the source computing environment to the target computing environment.

8. The non-transitory computer-readable medium of claim 1, wherein the operations further comprise:
prior to initiating the migration process, providing a report to the user indicating the network configuration data;
receiving a modification to the network configuration data from the user; and
after migrating the virtual machine to the target computing environment, configuring the virtual machine based on the modified network configuration data.

9. The non-transitory computer-readable medium of claim 8, wherein the report indicates (i) a set of applications executing on the virtual machine, (ii) a set of ports used by the set of applications in the virtual machine, (iii) a set of clients that accessed the set of applications via the set of ports, (iv) designations of each of the clients as internal or external to the source computing environment, and (v) one or more static IP addresses associated with the virtual machine.

10. A method comprising:
receiving, by one or more processors, a selection by a user of a virtual machine to migrate from a source computing environment to a target computing environment during a migration process;
based on receiving the selection, and prior to performing the migration process, determining, by the one or more processors, determine network configuration data associated with the virtual machine;
after determining the network configuration data, initiating, by the one or more processors, the migration process to migrate the virtual machine from the source computing environment to the target computing environment, wherein the migration process involves replacing a first network card driver used by the virtual machine at the source computing environment with a second network card driver used by the virtual machine in the target computing environment, and wherein replacing the first network card driver with the second network card driver during the migration process erases the network configuration data from the virtual machine; and
after deploying the virtual machine to the target computing environment, configuring, by the one or more processors, the virtual machine based on the network configuration data.

11. The method of claim 10, wherein the network configuration data specifies (i) a set of applications executing on the virtual machine, (ii) a set of ports used by the set of applications in the virtual machine, (iii) a set of clients that accessed the set of applications via the set of ports, and (iv) a static Internet Protocol (IP) address associated with the virtual machine.

12. The method of claim 11, wherein configuring the virtual machine involves:
assigning the static IP address to the virtual machine in the target computing environment;
opening the set of ports on the virtual machine in the target computing environment; and
generating a set of routes through the target computing environment from the set of clients to the set of applications.

13. The method of claim 12, wherein a client among the set of clients is external to the target computing environment, and wherein generating the set of routes involves establishing an endpoint that exposes at least one application of the set of applications externally to the client.

14. The method of claim 12, wherein a client among the set of clients is internal to the target computing environment, and wherein generating the set of routes involves establishing a pointer to at least one application of the set of applications, the client being configured to interact with the at least one application using the pointer.

15. The method of claim 10, further comprising:
determining whether the virtual machine is accessible to the one or more processors; and
based on determining that the virtual machine is accessible, inspecting the virtual machine to determine the network configuration data.

16. The method of claim 10, wherein the virtual machine is a first virtual machine and the network configuration data is first network configuration data, and further comprising:
determining that a second virtual machine is inaccessible to the one or more processors;
based on determining that the second virtual machine is inaccessible, foregoing inspecting the second virtual machine at the source computing environment; and
initiating the migration process to migrate the second virtual machine from the source computing environment to the target computing environment.

17. The method of claim 10, further comprising:
prior to initiating the migration process, providing a report to the user indicating the network configuration data;
receiving a modification to the network configuration data from the user; and
after migrating the virtual machine to the target computing environment, configuring the virtual machine based on the modified network configuration data.

18. The method of claim 17, wherein the report indicates (i) a set of applications executing on the virtual machine, (ii) a set of ports used by the set of applications in the virtual machine, (iii) a set of clients that accessed the set of applications via the set of ports, and (iv) designations of each of the clients as internal or external to the source computing environment.

19. A system comprising:
one or more processors; and
one or more memories including instructions that are executable by the one or more processors for causing the one or more processors to perform operations including:
receiving a selection by a user of a virtual machine to migrate from a source computing environment to a target computing environment during a migration process;
based on receiving the selection, and prior to performing the migration process, determining network configuration data associated with the virtual machine;
after determining the network configuration data, initiating the migration process to migrate the virtual machine from the source computing environment to the target computing environment, wherein the migration process involves replacing a first network card driver used by the virtual machine at the source computing environment with a second network card driver used by the virtual machine in the target computing environment, and wherein replacing the first network card driver with the second network card driver during the migration process erases the network configuration data from the virtual machine; and
after deploying the virtual machine to the target computing environment, configuring the virtual machine based on the network configuration data.

20. The system of claim 19, wherein the network configuration data specifies (i) an application executing on the virtual machine, (ii) an open port on the virtual machine, (iii) a client that accessed the virtual machine, or (iv) a static IP address associated with the virtual machine.
